(19) United States
(12) Patent Application Publication
(10) Pub. No.: US 2014/0198292 A1
(43) Pub. Date: Jul. 17, 2014

(54) DOUBLE-LENS DOUBLE-GROOVE ASSEMBLY

(71) Applicant: Carolyn NICKELL, Whittier, CA (US)

(72) Inventor: Carolyn NICKELL, Whittier, CA (US)

(21) Appl. No.: 13/740,667

(22) Filed: Jan. 14, 2013

(51) Int. Cl. G02B 7/02

(52) U.S. Cl. CPC G02B 7/021
USPC 351/154; 359/819

(57) ABSTRACT

A double-lens double-groove assembly including a frame and at least two adjacent grooves in or on the frame spaced to hold at least two lenses and at least a material between the lenses. The frame can be an eyeglass frame, a camera lens frame, a projector lens frame, or some other type of lens frame. The material can exhibit optical effects. Examples of the material can include but are not limited to a film or diffraction grating.

### BACKGROUND

The present disclosure relates to a double-lens double-groove assembly.

### SUMMARY

Aspects of the subject technology include a double-lens double-groove assembly. The assembly can include a frame and at least two adjacent grooves in or on the frame spaced to hold at least two lenses and at least a material between the two lenses. In some aspects, the frame is an eyeglass frame, a camera lens frame, or a projector lens frame. The material can exhibit optical effects. Examples of the material can include but are not limited to a film or diffraction grating.

This brief summary has been provided so that the nature of the invention may be understood quickly. A more complete understanding of the invention may be obtained by reference to the following description in connection with the attached drawings.

### BRIEF DESCRIPTION OF THE DRAWINGS

FIG. 1 shows material disposed between two lenses according to aspects of the subject technology.

FIG. 2 also shows material disposed between two lenses according to aspects of the subject technology.

FIG. 3 shows an example of part of an eyeglass frame with two grooves for holding a material between two lenses according to aspects of the subject technology.

FIG. 4 shows an example of a camera or projector frame with two grooves for holding a material between two lenses according to aspects of the subject technology.

### DETAILED DESCRIPTION

U.S. Provisional Application No. 61/590,840 filed 26 Jan. 2012 in the name of the same inventor is hereby incorporated by reference in its entirety as if fully set forth herein.

Lexicography

The following definitions are provided to assist with understanding of the subject technology. The definitions are not intended to be limiting, but rather are provided as examples.

Lens: a piece of transparent or tinted substance, that may be curved or flat, of which the intended function is to be looked through, photographed through, filmed through, and/or projected though.

Frame: A material (including but not limited to plastics, metal, and/or wood) that at least partially surrounds a lens. A frame does not necessarily completely surround a lens; there may be a gap in the frame. The frame serves as a mechanism to enable the lens to achieve its function (of being looked through, photographed through, filmed through, and/or projected through) by holding one or more lenses in place. Frames can hold one lens (like for camera features), two lenses (like in eyewear) or more. The subject technology is not limited to any particular number of lenses.

Groove: a narrow furrow or channel that can hold a lens in place within a frame. In many inexpensive sunglasses, for example, a lens is commonly held in place not with glue but by being inserted into a groove that is indented in the surface of the glasses frames. For example, much eyewear has one lens for each eye, and each lens is held in place by resting inside a single groove. (Aspects of the subject technology include two grooves to hold two lenses for each eye.) The frame can be created first and then a lens can be snapped into a groove in the frame by using pressure. In some aspects, a lens may also be snapped out of a groove by using pressure.

Inspiration

The subject technology was inspired by a particular problem. The usage potential of the technology is not limited to the following description of the problem.

The problem: Today a type of novelty eyewear is popular that permits the wearer to see spectrum rainbows around ordinary lights, or fireworks, for example. This eyewear uses diffraction grating film to achieve this rainbow effect, and the diffraction grating film creates this effect because of microscopic prismatic grooves on or in the film or its surface. People like to look through this film while enjoying music festivals because of the bright light displays that live music frequently showcases.

Many current eyewear options featuring this film are severely limited and flawed for this purpose. One may buy this film with paper eyeglass frames, which fall off one's face easily, bend and break, and the film is not protected, wrinkles and/or becomes dirty. Or, one may buy plastic-frame eyeglasses that feature this film in the place where one would ordinarily find a plastic lens, but the unprotected film can be thin and break, can wrinkle easily, can get dirty, and/or can get damaged.

The film often cannot be glued onto a lens because the adhesive fills the micro-grooves of the film, rendering its rainbow capacity ineffective and useless. Glue alternatively can be applied to the non-grooved side of the film. However, this arrangement can leave the microgrooves exposed to dirt and damage which can quickly render it useless. Another possible arrangement can involve using heat to attach the file. However, the heat can melt the grooves, thus potentially rendering the film useless.

Aspects of the subject technology address the foregoing issues with an arrangement including two lenses with a gap between them in which the film is inserted. This arrangement can provide a cost-effective, glue-free, protective, and sturdy method for allowing people to enjoy the rainbow-effect of diffraction grating film. In other aspects, glue, heat, or other mechanisms (e.g., methods, substances, and/or devices) can also be used to attach a film, with the lenses possibly providing protection for those mechanisms and/or the film or other material.

While the foregoing describes an inspiration for the subject technology, the technology is not limited to arrangements that address the issues that provided this inspiration and also is not limited to arrangements that enjoy all of the benefits discussed above.

Double-Lens Double-Groove Assembly

Aspects of the subject technology enable a material to be held (or exist or rest) between two lenses, thus altering the optical effect of the lens. The two lenses can function in the place of one lens. Thus, in some examples, the material can serve to alter the lens' effect without necessarily being attached to or secured between the lenses by heat, glue, or other methods or substances or devices except the double-lens double-groove assembly.

In some aspects, the double-lens double-groove assembly uses two lenses and two grooves where ordinarily might exist one lens held in place by one groove. For example, where other eyeglass frames would be one lens thick, the double-lens assembly can include two lenses. In other words, where other eyeglass frames would hold one lens before each eye, the double-lens assembly could hold two lenses before each eye. The material can be inserted between the lenses, for example in a gap region between the lenses. According to the subject technology, the grooves in the frame can hold the lenses in place when the lenses are snapped or otherwise inserted into the frame with the material between them.

Overview of the Subject Technology

(1) An eyewear frame or other lens-holding frame with two channels/grooves that hold the double-lens(es). Examples of these channels/grooves are the ones in some inexpensive plastic-frame sunglasses—the lenses are held in place by the channels/grooves rather than by glue (although this technology does not exclude the use of glue/adhesive).

(2) The double-lens: held in place by the double-grooves. (Ordinary eyewear usually has two lenses total; eyewear utilizing the double-lens assembly has four lenses—two on each side with a gap between each double-lens, one groove for each individual lens, four grooves total.)

The subject technology may be used by people who wear eyewear or use lenses, or in products that use lenses, for the purpose of altering the effect of the lens.

The technology does not exclude the use of tints, glues, adhesives, or other substances applied directly onto the lenses. In addition, the subject technology is not limited to the particulars of the foregoing overview.

The double-lens assembly can offer a cost-effective, durable, and protective way to utilize delicate and/or weak and/or thin materials (including but not limited to diffraction grating film) to alter the effect of lenses or the effect of looking (as looking through such material visually alters an optical experience). The double-lens can protect such material from the outside elements that include but are not limited to dust and water. In some aspects, the double-lens assembly can permit the user of the product to switch the material in and out or layer it in whatever way they wish because the grooves can permit the lenses to snap in and out. Additionally, aspects of the double-lens assembly allow the material to exist in the lens region without being attached by glue, temperature, or other substances or methods besides the double-lens double-groove assembly. The subject technology is not limited to arrangements that achieve all of these options and advantages.

Specific Examples

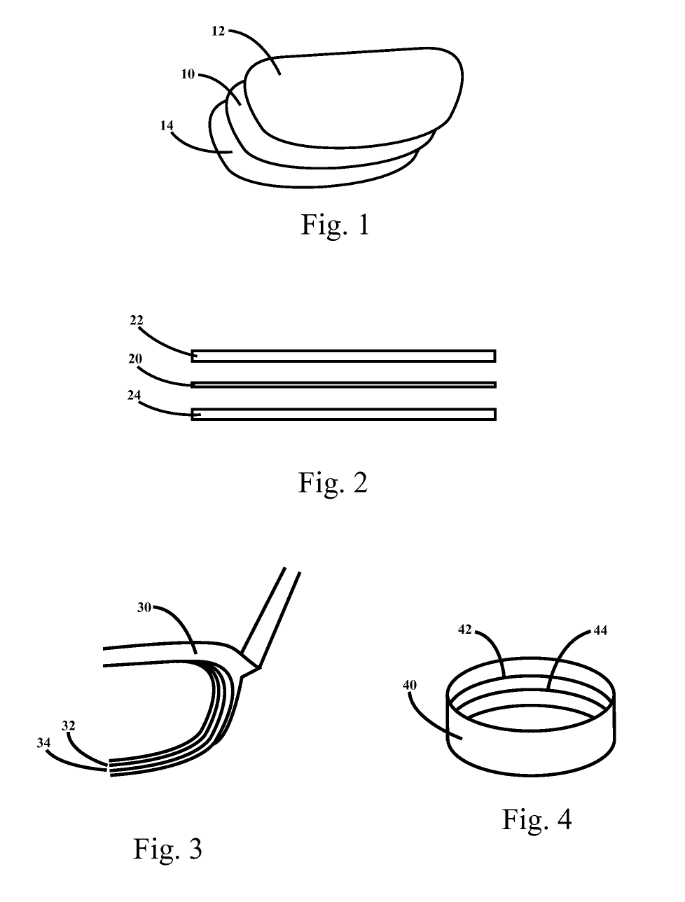

FIG. 1 shows material disposed between two lenses according to aspects of the subject technology. Material 10 is disposed between lenses 12 and 14. Material 10 preferably exhibits some form of optical effect, for example but not limited to a prismatic effect.

The material and lenses are shown as having an eyeglass lens shape. The subject technology is also applicable to other shapes of lenses. In addition, while the material and lenses are shown as having a same size and shape as each other, the subject technology is not limited to such. Rather, the material and lenses can have different shapes from each other. In addition, more than one piece of material 10 can be disposed between the lenses.

FIG. 2 also shows material disposed between two lenses according to aspects of the subject technology. In FIG. 2, material 20 is disposed between lenses 22 and 24. The material and lenses are shown as having a flat profile in this figure. In other aspects, the material and lenses can have other profiles, for example curved.

The material and lenses are shown spaced apart in FIGS. 1 and 2 for the sake of clarity. However, the lenses and material preferably are placed directly adjacent to each other. In other aspects, some space can remain between the material and one or both of the lenses.

FIG. 3 shows an example of part of an eyeglass frame with two grooves for holding two lenses according to aspects of the subject technology. In FIG. 3, frame 30 includes two grooves 32 and 34 for two lenses where a conventional eyeglass frame would hold only a single lens. When the lenses are placed in the grooves, a material that exhibits optical effects can be disposed and held between the lenses in a preferably protected manner.

Frame 30 is not limited to any particular design, type, and/or style of frame. For example, the frame can completely surround the lenses, or the frame can have a “gap” such as in the case of certain eyeglass frames that do not cover a bottom edge of the lenses.

FIG. 3 only shows one side of an eyeglass frame. Similar grooves can be disposed on the other side of the frame to accommodate additional material between two additional lenses.

FIG. 4 shows an example of a camera or projector frame with two grooves for holding a material between two lenses according to aspects of the subject technology. Frame 40 includes two grooves 42 and 44 for two lenses where a conventional frame would hold only a single lens. When the lenses are placed in the grooves, a material that exhibits optical effects can be disposed and held between the lenses in a protected manner. Again, the frame can completely surround the lenses as shown in FIG. 4, or the frame can have a “gap.”

The grooves in FIGS. 3 and 4 can have varying depths, for example to account for various different lenses or tolerances. In addition, in some examples of the subject technology, more than two lenses can be held in each position where a conventional frame would hold only one lens, possibly with optical material disposed between one or more pairs of adjacent lenses.

### CONCLUSION

While the foregoing written description of the technology enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Furthermore, the invention is in no way limited to the specifics of any particular embodiments and examples disclosed herein. For example, the terms “preferably,” “example,” “aspect,” and the like in the foregoing description denote features that are preferable but not essential to include in embodiments of the invention.

What is claimed is:

1. A double-lens double-groove assembly, comprising:
a frame; and
at least two adjacent grooves in or on the frame spaced to hold at least two lenses and at least a material between the two lenses.

2. The double-lens double-groove assembly as in claim 1, wherein
the frame comprises an eyeglass frame; and
the two adjacent grooves are positioned to hold the two lenses in front of a person's eye.

3. The double-lens double-groove assembly as in claim 2, further comprising two additional adjacent grooves in or on the frame spaced to hold two additional lenses and an additional material between the two additional lenses, wherein the two additional adjacent grooves are positioned to hold the two additional lenses in front of the person's other eye.

4. The double-lens double-groove assembly as in claim 1, wherein the frame comprises a camera lens frame.

5. The double-lens double-groove assembly as in claim 1, wherein the frame comprises a projector lens frame.

6. The double-lens double-groove assembly as in claim 1, further comprising the two lenses and the material.

7. The double-lens double-groove assembly as in claim 6, wherein the two lenses protect the material.

8. The double-lens double-groove assembly as in claim 7, wherein the material exhibits optical effects.

9. The double-lens double-groove assembly as in claim 7, wherein the material comprises a film.

10. The double-lens double-groove assembly as in claim 9, wherein the film comprises a grating.

11. A double-lens double-groove assembly, comprising:
a frame; and
two adjacent grooves in or on the frame spaced to hold two lenses and a material between the two lenses.

12. The double-lens double-groove assembly as in claim 11, wherein
the frame comprises an eyeglass frame; and
the two adjacent grooves are positioned to hold the two lenses in front of a person's eye.

13. The double-lens double-groove assembly as in claim 12, further comprising two additional adjacent grooves in or on the frame spaced to hold two additional lenses and an additional material between the two additional lenses, wherein the two additional adjacent grooves are positioned to hold the two additional lenses in front of the person's other eye.

14. The double-lens double-groove assembly as in claim 11, wherein the frame comprises a camera lens frame.

15. The double-lens double-groove assembly as in claim 11, wherein the frame comprises a projector lens frame.

16. The double-lens double-groove assembly as in claim 11, further comprising the two lenses and the material.

17. The double-lens double-groove assembly as in claim 16, wherein the two lenses protect the material.

18. The double-lens double-groove assembly as in claim 17, wherein the material exhibits optical effects.

19. The double-lens double-groove assembly as in claim 17, wherein the material comprises a film.

20. The double-lens double-groove assembly as in claim 19, wherein the film comprises a grating.
